(19) United States
(12) Patent Application Publication
(10) Pub. No.: US 2009/0234739 A1
(43) Pub. Date: Sep. 17, 2009

(54) Multi-level real estate method and system

(76) Inventor: Lawrence Richard Smith, Cape Coral, FL (US)

Correspondence Address: GEORGE F. WALLACE, ESQ., 2010 WILLOW BRANCH DRIVE, CAPE CORAL, FL, 33991, US

(21) Appl. No.: 12/380,673

(22) Filed: Mar. 2, 2009

Related U.S. Application Data
(60) Provisional application No. 61/067,412, filed on Feb. 28, 2008.

(51) Int. Cl. G06Q 50/00; G06Q 30/00

(52) U.S. Cl. 705/14; 705/1

(57) ABSTRACT

A method of compensating a plurality of participants includes forming a multi-level real estate team based upon sponsoring of members into the team, the team having at least some of the members having sponsored at least one subsequent level of members into the team; collecting a fee from each member in the team; placing the collected fees into a revenue pool; distributing a team bonus from the revenue pool to one or more of the members based upon at least: (i) a first level portion of the revenue pool, and (ii) a second level portion of the revenue pool.

### RELATED AND PRIORITY DOCUMENTS

This disclosure is related to, incorporates by reference in its entirety, and claims the priority benefit of U.S. Provisional Patent Application Ser. No. 61/067,412 filed by SMITH on Feb. 28, 2008.

### FIELD OF THE INVENTION

The present invention relates to real estate, and more specifically, to multi-level real estate.

### BACKGROUND OF THE INVENTION

Real estate methods and systems are geared towards real estate sales. Multi-level methods and systems are geared towards incentivizing those involved in facilitating real estate sales.

### BRIEF SUMMARY OF THE INVENTION

It is, therefore, an object of the present invention to provide a multi-level real estate method and system.

A method of compensating a plurality of participants includes forming a multi-level real estate team based upon sponsoring of members into the team, the team having at least some of the members having sponsored at least one subsequent level of members into the team; collecting a fee from each member in the team; placing the collected fees into a revenue pool; distributing a team bonus from the revenue pool to one or more of the members based upon at least: (i) a first level portion of the revenue pool, and (ii) a second level portion of the revenue pool.

### BRIEF DESCRIPTION OF DRAWINGS

FIGS. 1-28 depict exemplary aspects of the invention.

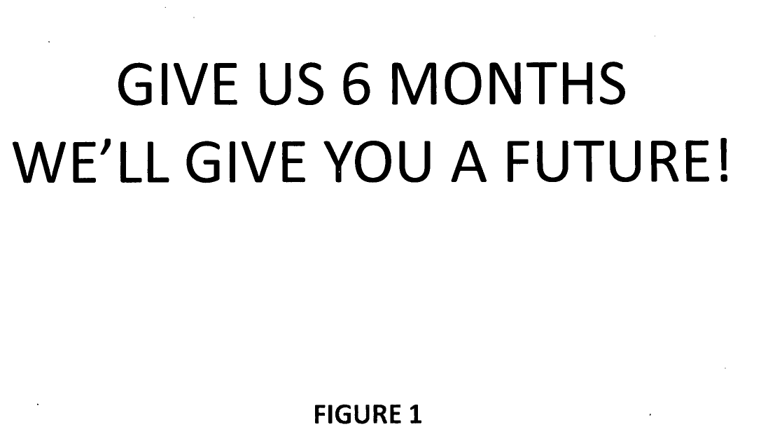

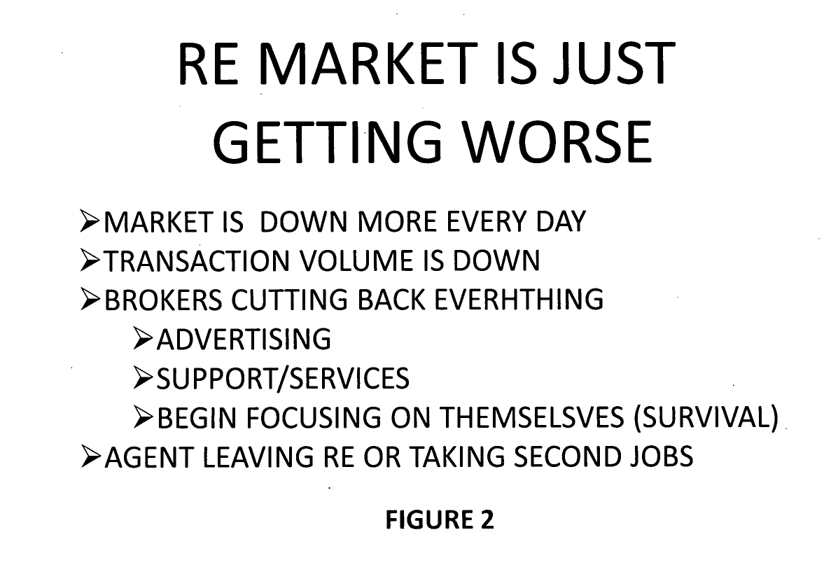

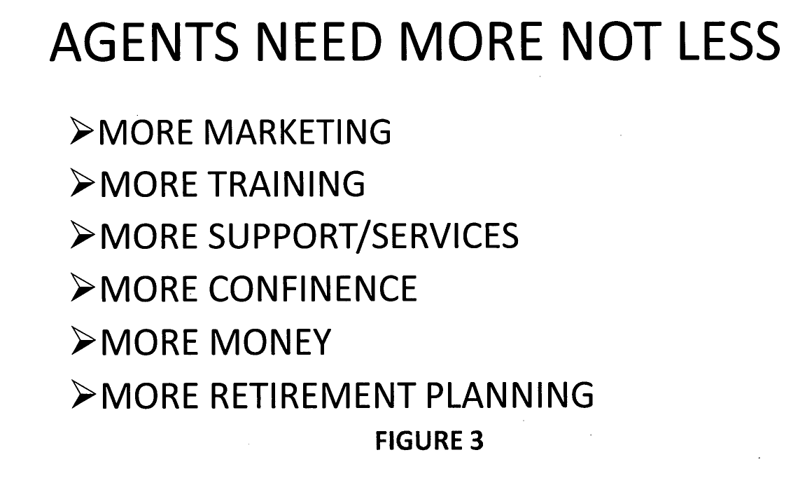

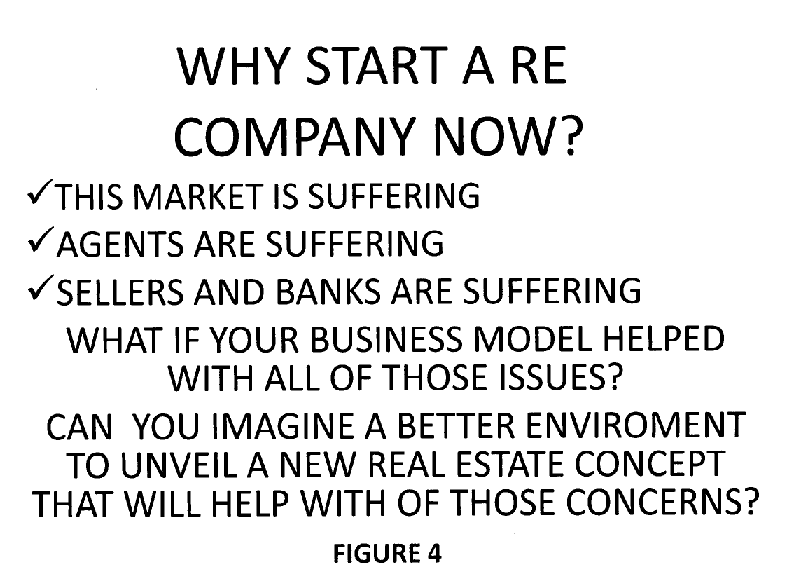

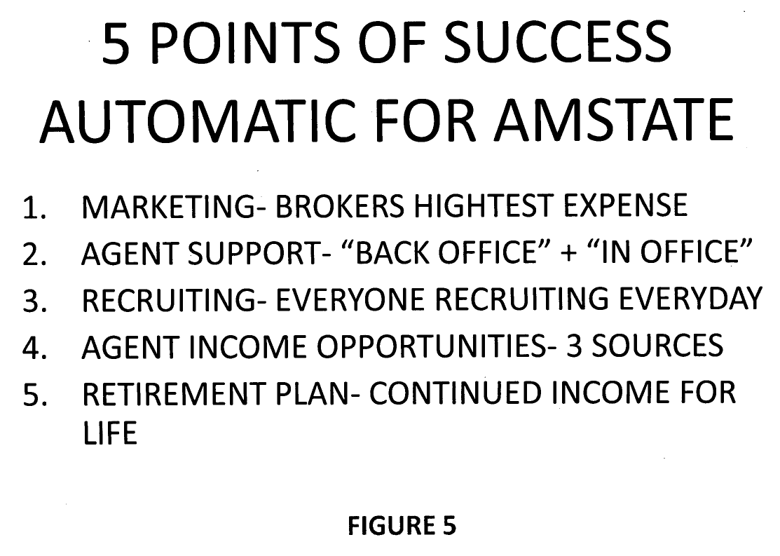

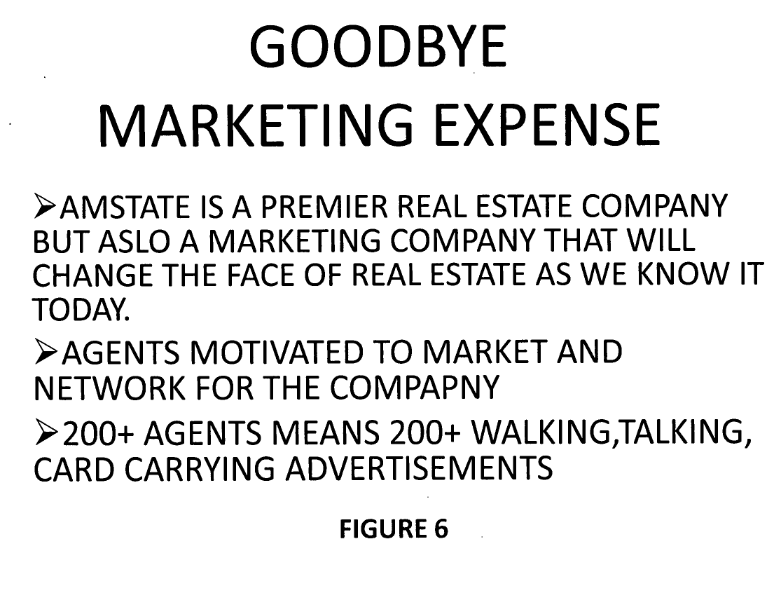

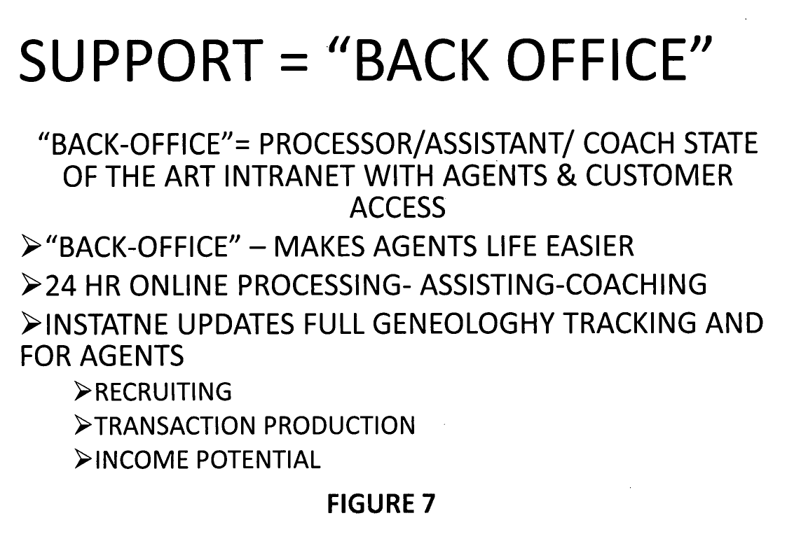

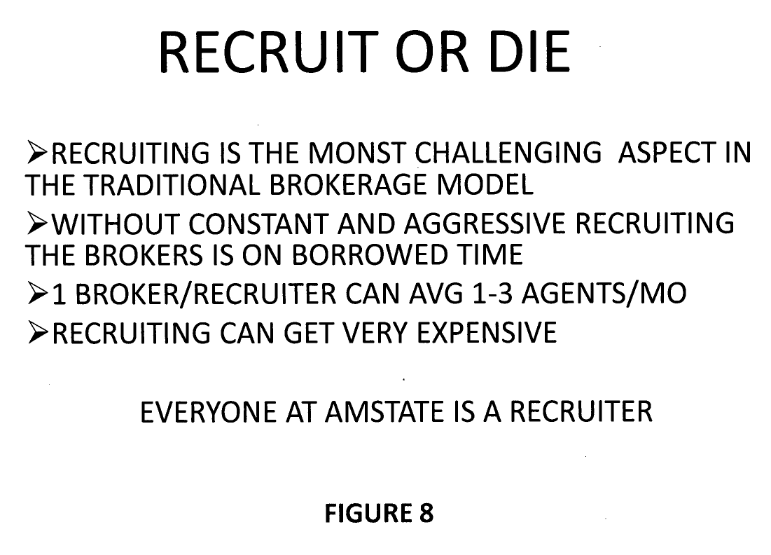

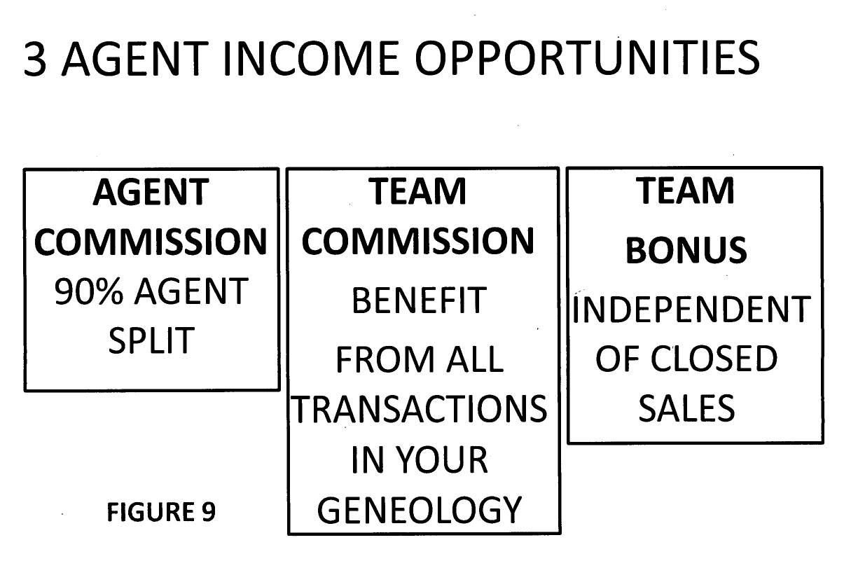

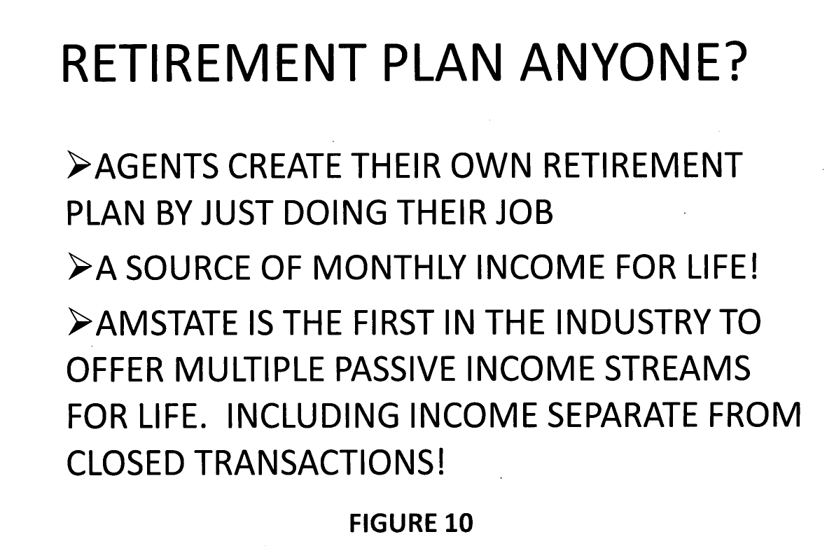

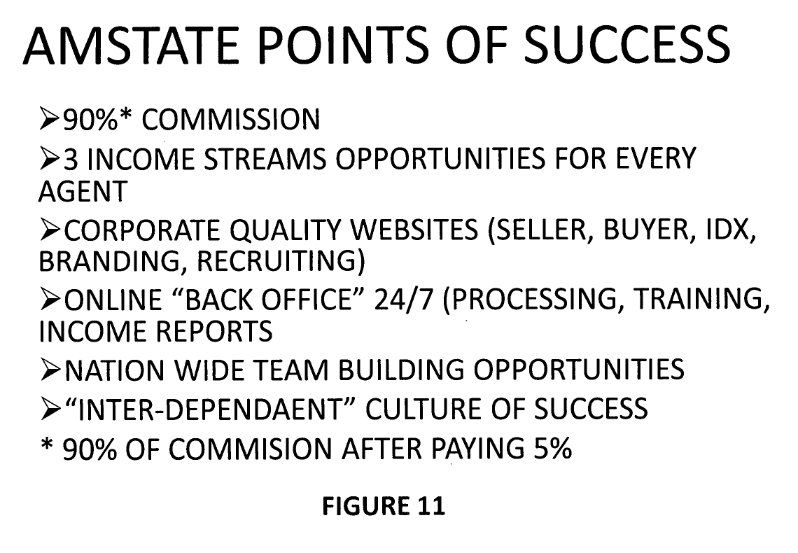

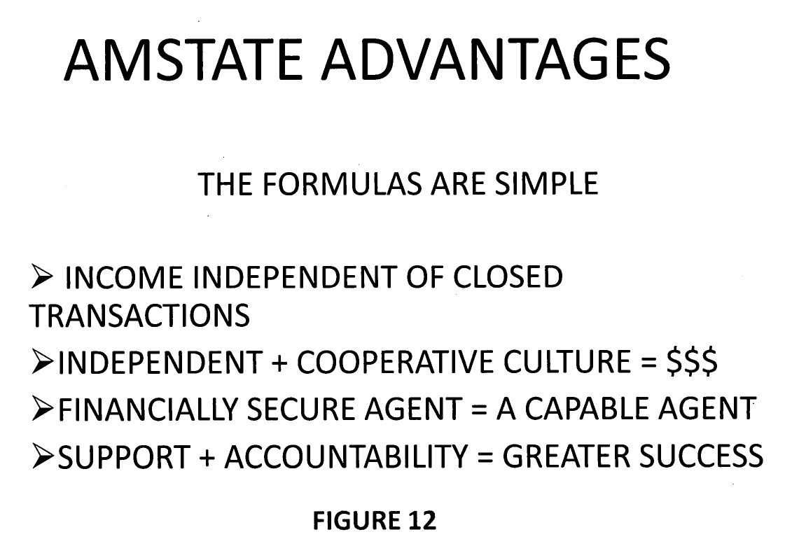

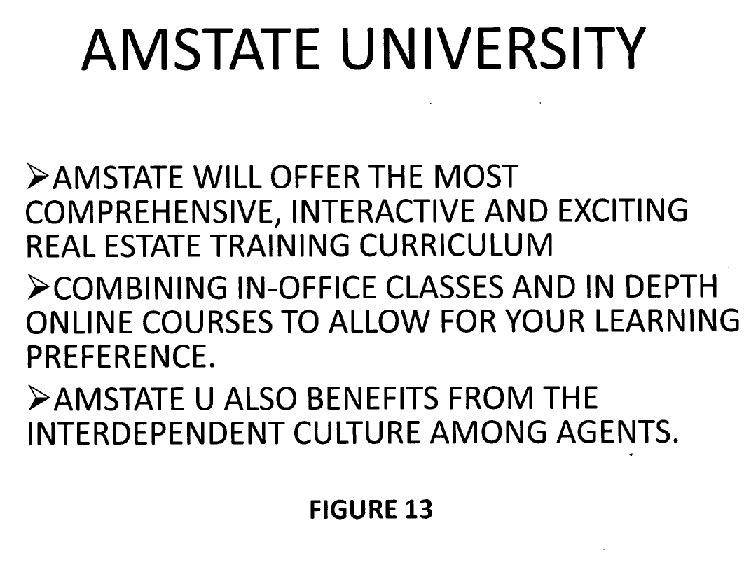

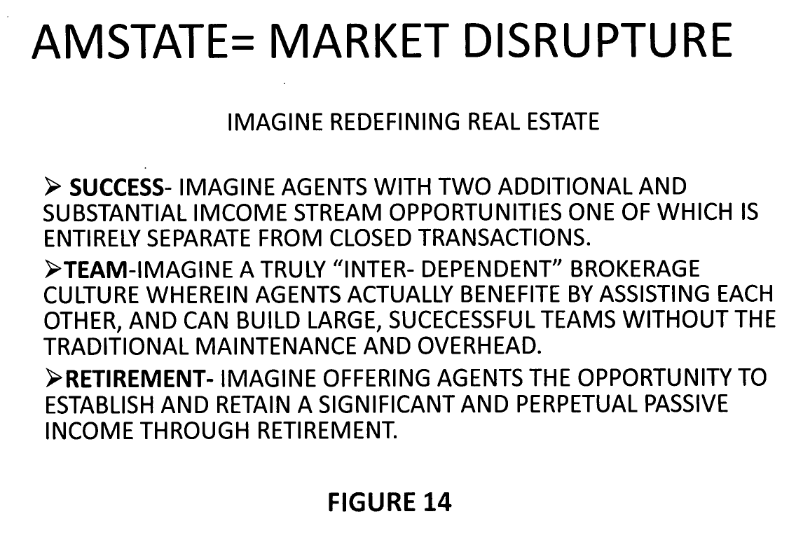

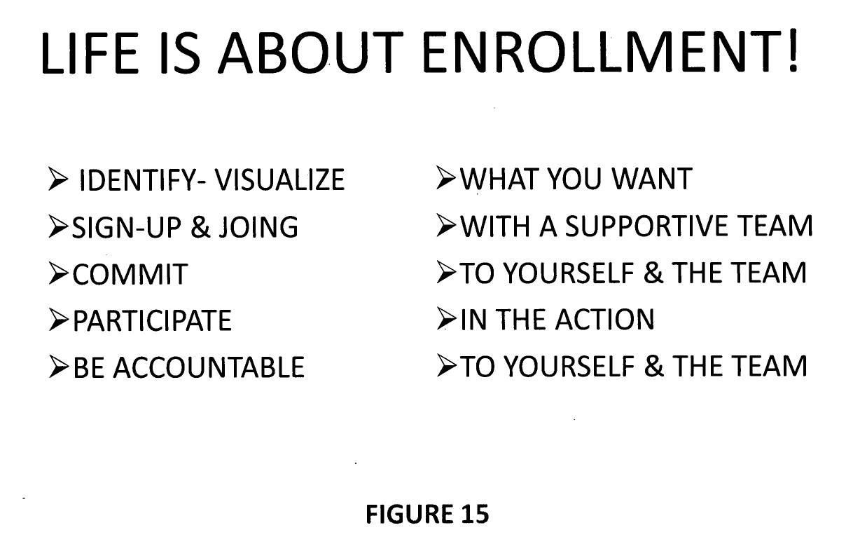

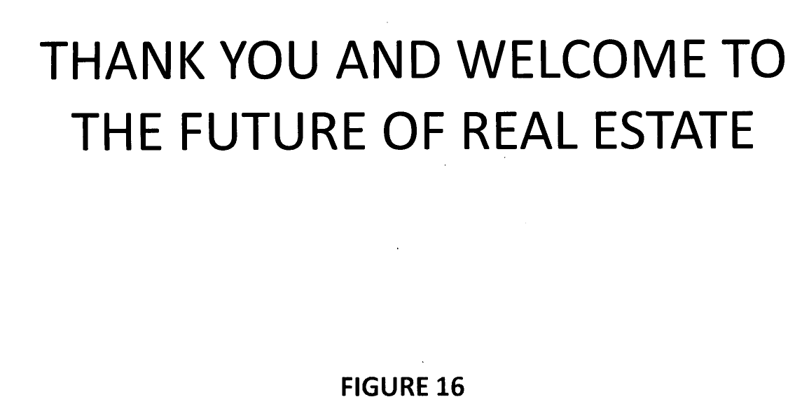

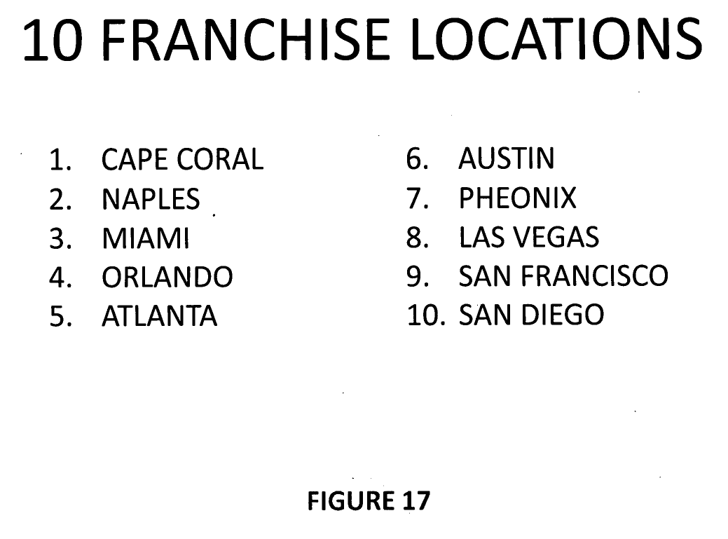

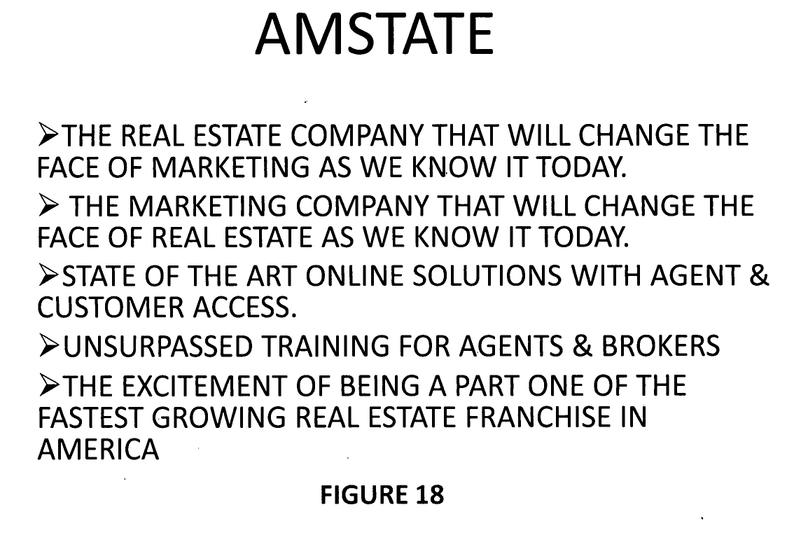

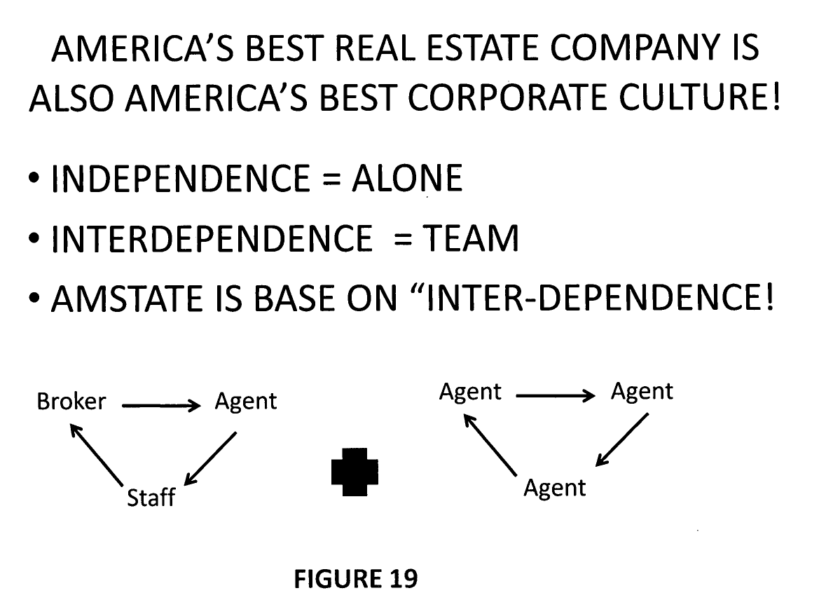

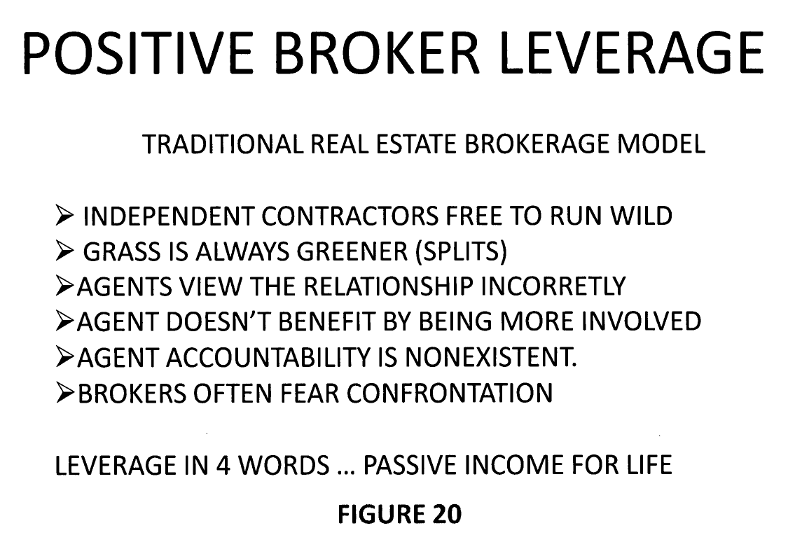

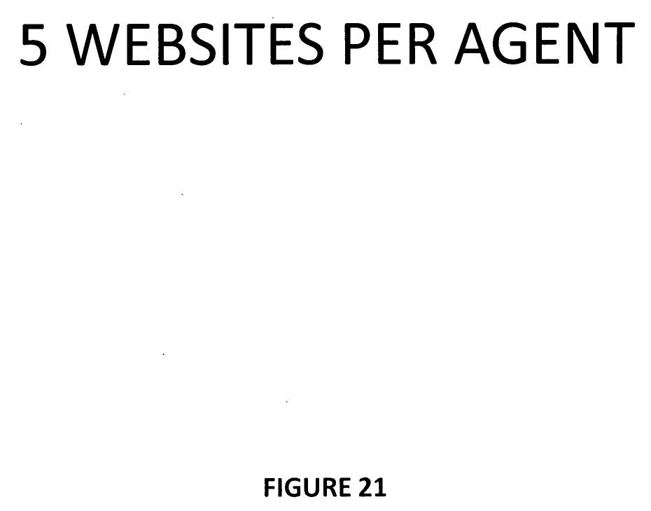

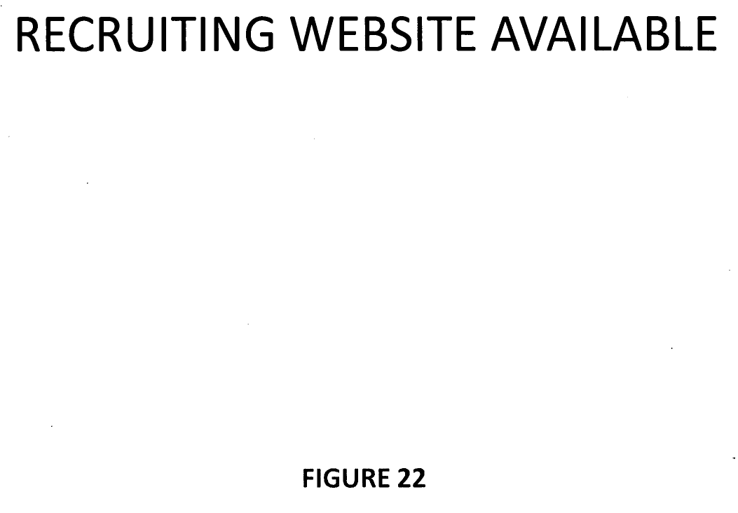

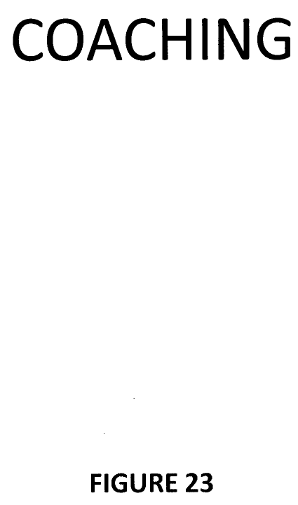

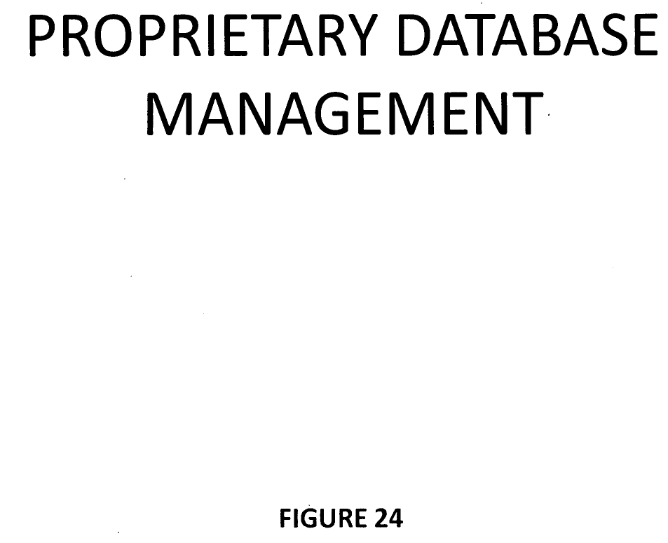

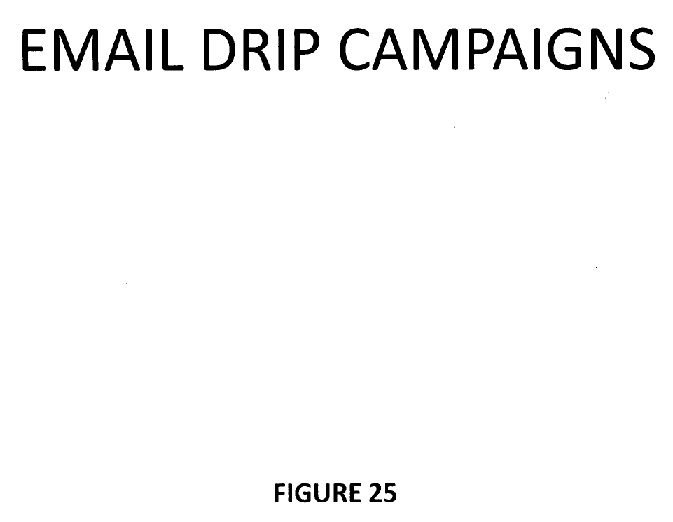

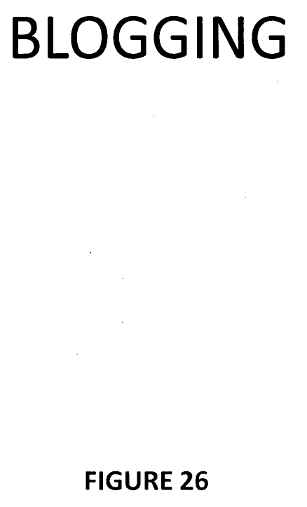

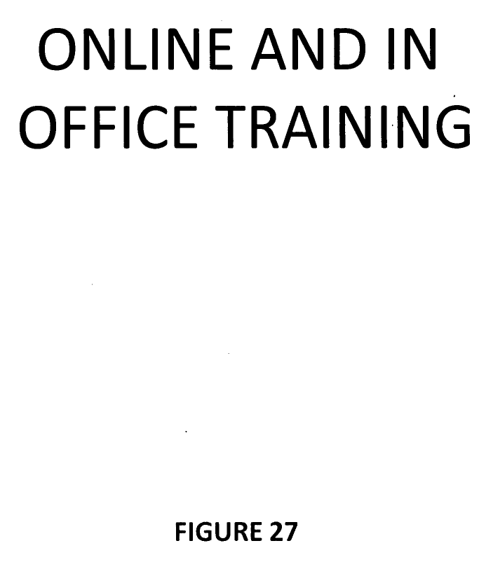

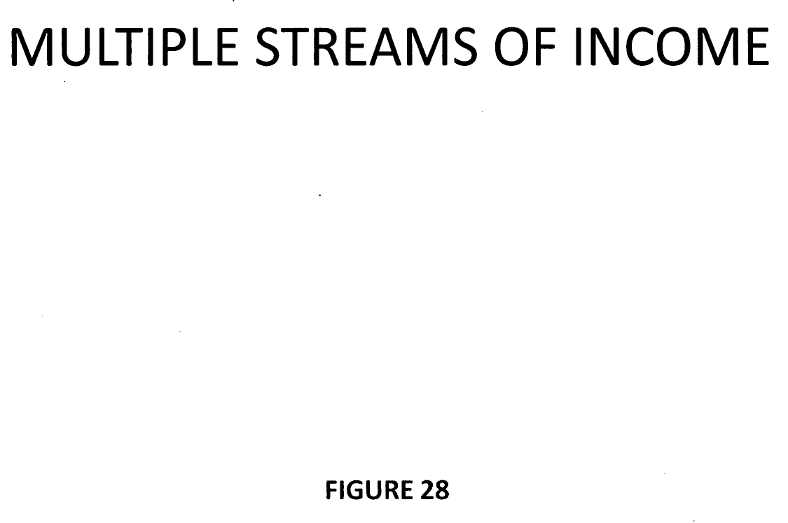

### DETAILED DESCRIPTION

A method of compensating a plurality of participants, comprising the steps of:
forming a multi-level real estate team based upon sponsoring of members into the team, the team having at least some of the members having sponsored at least one subsequent level of members into the team;
collecting a fee from each member in the team;
placing the collected fees into a revenue pool;
distributing a team bonus from the revenue pool to one or more of the members based upon at least: (i) a first level portion of the revenue pool, and (ii) a second level portion of the revenue pool.

The method above wherein an combination of the following exists:
at least one member is one of a selling agent, a listing agent, a real estate broker, a title agent, and a lender;
the fee is not based on the sale of real estate;
such a team member receives a team bonus for each other productive team member that the such a team member has recruited;
the fee is not based on the lease of real estate;
a bonused member receives a team bonus if that member sponsored another member that was productive;
the other member must be real estate-based productive; and
the each other productive member uis real-estate-based productive.

It will be apparent to one skilled in the art that the manner of making and using the claimed invention has been adequately disclosed in the above-written description of the exemplary embodiments and aspects taken together with the drawings.

It should be understood, however, that the invention is not necessarily limited to the specific embodiments, aspects, arrangement, and components shown and described above, but may be susceptible to numerous variations within the scope of the invention. Accordingly, the specification and drawings are to be regarded in an illustrative and enabling, rather than a restrictive, sense.

Therefore, it will be understood that the above description of the embodiments of the present invention are susceptible to various modifications, changes, and adaptations, and the same are intended to be comprehended within the meaning and range of equivalents of the appended claims.

Therefore, I claim:

1. A method of compensating a plurality of participants, comprising the steps of:
forming a multi-level real estate team based upon sponsoring of members into the team, the team having at least some of the members having sponsored at least one subsequent level of members into the team;
collecting a fee from each member in the team;
placing the collected fees into a revenue pool;
distributing a team bonus from the revenue pool to one or more of the members based upon at least: (i) a first level portion of the revenue pool, and (ii) a second level portion of the revenue pool.

2. The method of claim 1, wherein at least one member is one of a selling agent, a listing agent, a real estate broker, a title agent, and a lender.

3. The method of claim 1, wherein said fee is not based on the sale of real estate.

4. The method of claim 1, wherein said fee is not based on the least of real estate.

5. The method of claim 1, wherein a bonused member receives a team bonus if that member sponsored another member that was productive.

6. The method of claim 5, wherein the other member muyst be real estate-based productive.

7. The method of claim 1, wherein such a team member receives a team bonus for each other productive team member that the such a team member has recruited.

8. The method of claim 7, wherein the each other productive member uis real-estate-based productive.
